(19) United States
(12) Patent Application Publication
(10) Pub. No.: US 2020/0018100 A1
(43) Pub. Date: Jan. 16, 2020

(54) OCCUPANT ASSISTING APPARATUS, METHOD, AND PROGRAM

(71) Applicant: OMRON Corporation, Kyoto-shi, KYOTO (JP)

(72) Inventors: Hatsumi AOI, Kyoto-shi (JP); Hiroshi SUGAHARA, Kyoto-shi (JP); Kazuyoshi OKAJI, Kyoto-shi (JP); Michie UNO, Kyoto-shi (JP); Koji TAKIZAWA, Kyoto-shi (JP)

(73) Assignee: OMRON Corporation, Kyoto-shi, KYOTO (JP)

(21) Appl. No.: 16/335,276

(22) PCT Filed: Jul. 20, 2017
(86) PCT No.: PCT/JP2017/026353

§ 371 Date: Mar. 21, 2019

(30) Foreign Application Priority Data
Mar. 7, 2017 (JP) 2017-042693

(51) Int. Cl. E05B 77/00; G01C 21/34

(52) U.S. Cl. CPC E05B 77/00; G01C 21/3407

(57) ABSTRACT

In an occupant assisting apparatus, a destination arrival determination unit determines whether a vehicle has arrived at a destination of an occupant, a situation determination unit determines whether a surrounding situation is safe for the occupant to exit the vehicle based on a sensing result obtained from a surrounding situation detection sensor for detecting the surrounding situation of the vehicle when the destination arrival determination unit determines that the vehicle has arrived at the destination, and a door lock controller unlocks a door at a doorway of the vehicle when the surrounding situation is determined to be safe for the occupant to exit the vehicle.

### FIELD

The present invention relates to an occupant assisting apparatus, an occupant assisting method, and an occupant assisting program for assisting an occupant of a vehicle.

### BACKGROUND

Vehicles incorporating an automatic driving controller that assists vehicle driving operations have been developed and commercialized.

A variety of assisting apparatuses have been developed for assisting a driver in a vehicle with an automatic driving controller. For example, Japanese Unexamined Patent Application Publication No. 2014-044707 (Patent Literature 1) describes an assisting apparatus that assists a driver in an abnormal condition by determining the driver's health and assisting the driver in a low state of health depending on the level of the state.

Japanese Unexamined Patent Application Publication No. 2005-054487 (Patent Literature 2) describes a keyless entry apparatus that prevents a collision caused by a user opening a vehicle door without noticing an approaching other vehicle.

### SUMMARY

An assisting apparatus that assists a driver in an abnormal condition is thus known, as one example is described in Patent Literature 1. However, passengers who do not operate a vehicle, other than a driver, also board a vehicle with an automatic driving controller. An occupant assisting apparatus may assist not only a driver but all occupants of a vehicle including a driver and passengers.

Patent Literature 2 describes a technique for preventing a collision caused by a user opening a door immediately before starting to drive, but not after arriving at a destination.

One or more aspects of the present invention are directed to an occupant assisting apparatus, an occupant assisting method, and an occupant assisting program for assisting an occupant of a vehicle after the vehicle has arrived at a destination.

In response to the above issue, an occupant assisting apparatus according to a first aspect of the present invention assists an occupant on a vehicle. The apparatus includes a destination arrival determination unit that determines whether the vehicle has arrived at a destination of the occupant, a situation determination unit that determines whether a surrounding situation is safe for the occupant to exit the vehicle based on a sensing result obtained from a surrounding situation detection sensor for detecting the surrounding situation of the vehicle when the destination arrival determination unit determines that the vehicle has arrived at the destination, and a door lock controller that unlocks a door at a doorway of the vehicle when the situation determination unit determines that the surrounding situation is safe for the occupant to exit the vehicle.

An occupant assisting apparatus according to a second aspect of the present invention is the apparatus according to the first aspect in which the situation determination unit determines whether a moving object around the doorway is approaching the door based on the sensing result obtained from the surrounding situation detection sensor, and determines whether the surrounding situation is safe for the occupant to exit the vehicle based on a result of the determination.

An occupant assisting apparatus according to a third aspect of the present invention is the apparatus according to the first or second aspect further including a destination storage that stores the destination of the occupant. The destination arrival determination unit determines whether the vehicle has arrived at the destination stored in the destination storage based on a sensing result obtained from a current position detection sensor for detecting a current position of the vehicle.

An occupant assisting apparatus according to a fourth aspect of the present invention is the apparatus according to the first or second aspect in which the vehicle is an automated vehicle for automatically driving to a destination under control by an automatic driving controller included in the vehicle, and the destination arrival determination unit determines whether the vehicle has arrived at a destination in response to a signal indicating the arrival at the destination output from the automatic driving controller.

An occupant assisting method according to a fifth aspect of the present invention is implemented by an apparatus for assisting an occupant on a vehicle. The method includes determining whether the vehicle has arrived at a destination of the occupant, determining whether a surrounding situation is safe for the occupant to exit the vehicle based on a sensing result obtained from a surrounding situation detection sensor for detecting the surrounding situation of the vehicle when the vehicle is determined to have arrived at the destination in the determining whether the vehicle has arrived at the destination, and controlling door lock to unlock a door at a doorway of the vehicle when the surrounding situation is determined to be safe for the occupant to exit the vehicle in the determining whether the surrounding situation is safe.

A program according to a sixth aspect of the present invention causes a computer to function as the units included in the occupant assisting apparatus according to any one of the first to fourth aspects.

The apparatus and the method according to the first and fifth aspects of the present invention determine whether a vehicle has arrived at a destination of an occupant, and detects the situation surrounding the vehicle when the vehicle arrives at the destination. When the surrounding situation is safe for the occupant to exit the vehicle, the apparatus unlocks a door at a doorway of the vehicle to allow the occupant to exit the vehicle. Thus, the door remains locked and the occupant remains on board until an approaching moving object, such as a bicycle approaching from behind the vehicle, passes by the vehicle. This structure prevents an occupant from exiting the vehicle without noticing an approaching bicycle and colliding with the bicycle, and thus assists in ensuring the safety of the occupant. This structure also prevents a bicycle or another moving object from colliding with a vehicle door that may be carelessly open by an occupant of the vehicle. This structure thus not only ensures the safety of the bicycle rider, but also prevents troubles between the vehicle occupant and the bicycle rider.

The apparatus according to the second aspect of the present invention determines whether the surrounding situation is safe for the occupant to exit the vehicle by determining whether a moving object is approaching the door. When a moving object such as a bicycle is approaching the door, the door remains locked.

The apparatus according to the third aspect of the present invention easily determines whether the vehicle has arrived at the destination by comparing the destination stored in advance with the current position of the vehicle.

The apparatus according to the fourth aspect of the present invention detects the arrival of the vehicle without a position detection sensor when the vehicle has arrived at the destination under control by the automatic driving controller. This structure thus reduces the cost.

The program according to the sixth aspect of the present invention causes the computer to function as the units included in the occupant assisting apparatus according to any one of the first to fourth aspects.

The occupant assisting apparatus, method, and program according to these aspects of the present invention assist an occupant of a vehicle.

### BRIEF DESCRIPTION OF THE DRAWINGS

FIG. 1 is a schematic diagram of an automatic driving control system including an occupant assisting apparatus according to one embodiment of the present invention.

FIG. 2 is a functional block diagram of the occupant assisting apparatus according to the embodiment of the present invention.

FIG. 3 is a flowchart showing the procedure and the operation for assisting an occupant performed by the occupant assisting apparatus shown in FIG. 2.

### DETAILED DESCRIPTION

### Embodiment

One embodiment of the present invention will now be described with reference to the drawings.

### Embodiment

Structure

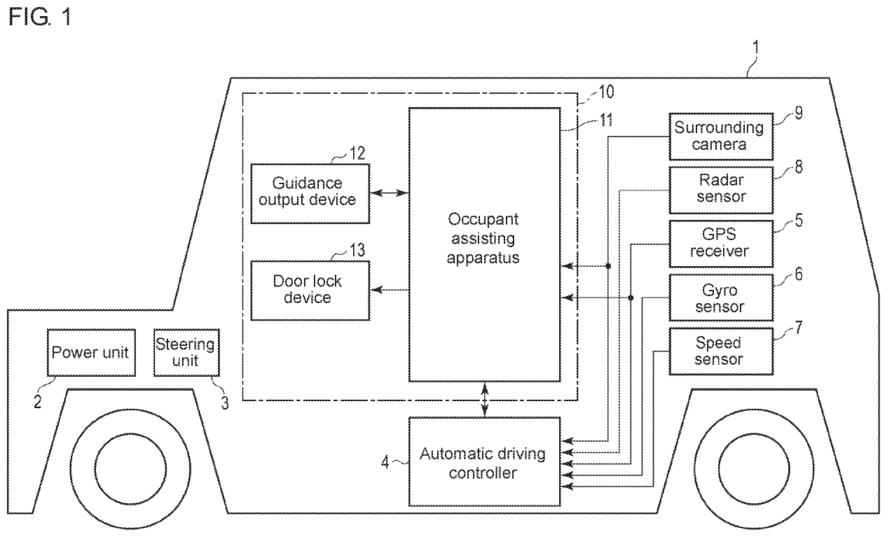

FIG. 1 is a schematic diagram of an automatic driving control system including an occupant assisting apparatus according to one embodiment of the present invention. The automatic driving control system is mounted on a vehicle 1. The vehicle 1 may be a driverless, fully automated taxi in this embodiment.

The vehicle 1 includes, as its basic components, a power unit 2 including a power supply and a transmission, and a steering unit 3. The power supply includes an engine, a motor, or both.

The vehicle 1 can travel in a driverless automatic drive mode. For example, the automatic drive mode enables a driving status in which the vehicle 1 automatically travels a roadway to a destination specified by a taxi passenger, without a driver performing a driving operation. The vehicle 1 may switch to a manual drive mode as appropriate, in which the driver operates the vehicle 1.

In FIG. 1, the vehicle 1 includes an automatic driving controller 4 for controlling driving in the automatic drive mode. The automatic driving controller 4 obtains sensing data from a global positioning system (GPS) receiver 5, a gyro sensor 6, and a speed sensor 7. The automatic driving controller 4 automatically controls the traveling of the vehicle 1 by controlling the steering, the accelerator, and the brake based on route information generated by a navigation system (not shown), traffic information obtained through road-to-vehicle communication, and information obtained by a surrounding monitoring system that monitors the positions and movements of nearby pedestrians and vehicles. The surrounding monitoring system includes, for example, a radar sensor 8 and a surrounding camera 9. The radar sensor 8 measures a distance to an object (e.g., a moving object, such as a vehicle or a person, and to a still object, such as a wall) around the vehicle, and outputs the distance information to the automatic driving controller 4. The surrounding camera 9 captures images of areas surrounding the vehicle, and outputs video signals representing the captured images to the automatic driving controller 4.

The automatic driving control includes autosteering (automatic steering during driving) and automatic speed regulation (automatic speed regulation during driving). Autosteering enables a driving state in which the steering unit 3 is controlled automatically. Autosteering includes lane keeping assist (LKA). LKA automatically controls the steering unit 3 to prevent the vehicle 1 from leaving the driving lane. Autosteering is not limited to LKA. Automatic speed regulation enables a driving state in which the speed of the vehicle 1 is controlled automatically. Automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs tracking control to regulate the speed of the vehicle 1 in accordance with the distance from the preceding vehicle. Automatic speed regulation is not limited to ACC, but may include cruise control (CC).

The automatic driving control system according to the present embodiment includes an occupant assisting system 10 for assisting the driver of the vehicle 1. The occupant assisting system 10 includes the occupant assisting apparatus 11 according to the embodiment of the present invention, and a guidance output device 12 and a door lock device 13, which are connected to the occupant assisting apparatus 11.

The guidance output device 12 outputs guidance information received from the occupant assisting apparatus 11. For example, the guidance output device 12 includes a speaker and a display. The guidance output device 12 outputs, from the speaker, a sound signal representing the guidance information output from the occupant assisting apparatus 11, and displays a display signal representing the guidance information on the display. The guidance information includes at least information indicating that the vehicle 1 has arrived at the destination.

The guidance output device 12 may include, as a part of a taxi system included in a taxi with fully automated driving, for example, the same functions as the image display function, the touch input function, and the sound input and output function of the navigation system to allow an occupant to enter the destination. The guidance output device 12 outputs information indicating the input destination to the occupant assisting apparatus 11.

The guidance output device 12 may further have, for example, a card reader function as a part of the taxi system to read information from, for example, a credit card, a prepaid card, and a membership card, and may receive a fare from the occupant. The guidance output device 12 may also have an automatic cash receipt and change returning function for fare payment in cash.

The guidance output device 12 may eliminate some of the components described above, and may include any other components that at least enable an occupant to be informed when the vehicle 1 arrives at the destination.

The door lock device 13 is installed on the door at each doorway of the fully automated vehicle to lock or unlock the door as controlled by the occupant assisting apparatus 11.

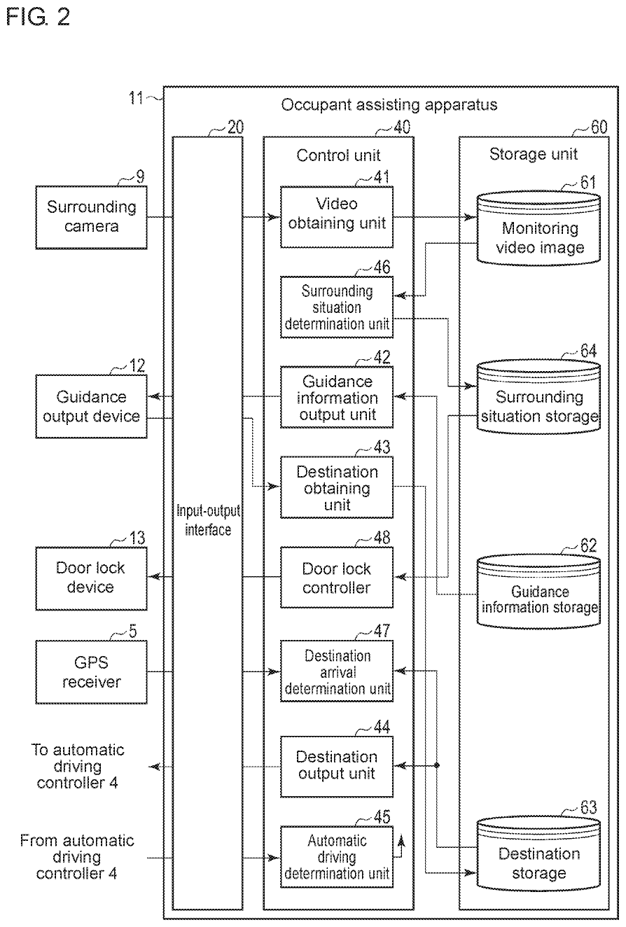

The occupant assisting apparatus 11, which assists the occupant, has the structure described below. FIG. 2 is a functional block diagram of the occupant assisting apparatus 11.

The occupant assisting apparatus 11 includes an input-output interface 20, a control unit 40, and a storage unit 60.

The input-output interface 20 receives video signals output from the surrounding camera 9, converts the received signals into digital data, and inputs the digital data into the control unit 40. The input-output interface 20 also receives current positional information indicating the current position of the vehicle 1 from the GPS receiver 5, and inputs the information into the control unit 40. The input-output interface 20 further receives the occupant's destination information output from the guidance output device 12, and inputs the information into the control unit 40.

The input-output interface 20 converts the guidance information output from the control unit 40 into a sound signal and a display signal, and outputs the signals to the guidance output device 12. The input-output interface 20 also converts door control information output from the control unit 40 into a door lock or unlock signal, and outputs the signal to the door lock device 13.

The input-output interface 20 further communicates information between the automatic driving controller 4 and the control unit 40.

The storage unit 60 includes, as storage media, a nonvolatile memory, such as a solid state drive (SSD) or a hard disk drive (HDD), which is writable and readable as appropriate. The storage unit 60 may also include a volatile memory, such as a random access memory (RAM). The storage unit 60 includes, as storage areas used for implementing the present embodiment, a monitoring video storage 61, a guidance information storage 62, a destination storage 63, and a surrounding situation storage 64. The monitoring video storage 61 stores monitoring videos of areas surrounding the vehicle 1. The guidance information storage 62 stores the guidance information. The destination storage 63 stores a destination. The surrounding situation storage 64 stores information indicating whether the surrounding situation is safe for the occupant to exit the vehicle 1 at each doorway.

The control unit 40 includes, as its control functions for implementing the present embodiment, a video obtaining unit 41, a guidance information output unit 42, a destination obtaining unit 43, a destination output unit 44, an automatic driving determination unit 45, a surrounding situation determination unit 46, a destination arrival determination unit 47, and a door lock controller 48. The control unit 40 may be a computer including a central processing unit (CPU) and a program memory, and any of the control functions may be implemented by the CPU executing programs stored in the program memory.

The video obtaining unit 41 obtains monitoring videos of areas surrounding the vehicle 1 from the surrounding camera 9. The video obtaining unit 41 receives, through the input-output interface 20, digital data (surrounding monitoring video data) for video signals output from the surrounding camera 9, and stores the received surrounding monitoring video data into the monitoring video storage 61 included in the storage unit 60.

The surrounding camera 9 or the input-output interface 20 may encode the video signals with a predetermined encoding scheme. This reduces the amount of surrounding monitoring video data, thus saving the memory capacity of the monitoring video storage 61.

The video obtaining unit 41 does not necessarily obtain all the monitoring videos from the surrounding camera 9, and may obtain videos when the vehicle 1 is parked or after the vehicle 1 arrives at the destination.

The guidance information output unit 42 reads the prestored guidance information from the guidance information storage 62, and outputs the information to the guidance output device 12.

The destination obtaining unit 43 obtains the destination of the passenger, who is an occupant. The destination obtaining unit 43 reads the destination information input from the guidance output device 12, and stores the information into the destination storage 63 included in the storage unit 60.

The destination output unit 44 outputs the passenger destination to the automatic driving controller 4. The destination output unit 44 reads the destination information stored in the destination storage 63, and outputs the information to the automatic driving controller 4.

The automatic driving determination unit 45 determines an automatic driving state in which, for example, the vehicle 1 is currently traveling, is parked, or has arrived at the destination based on various items of information about automatic driving output from the automatic driving controller 4. The control unit 40 causes each of the units to function to implement the present embodiment based on the determination result from the automatic driving determination unit 45.

The surrounding situation determination unit 46 determines the situation surrounding the vehicle 1 and determines whether the surrounding situation is safe for the passenger to exit the vehicle. The surrounding situation determination unit 46 reads the surrounding monitoring video data from the monitoring video storage 61, and determines whether the surrounding situation is safe for each passenger on the vehicle 1 to exit the vehicle at the corresponding doorway. The surrounding situation determination unit 46 stores the determination result into the surrounding situation storage 64.

For example, the surrounding situation determination unit 46 determines whether a moving object at a predetermined distance from a doorway, such as a bicycle or a person, is approaching the door, and determines whether the surrounding situation is safe for the passenger to exit the vehicle based on the determination result. More specifically, the surrounding situation determination unit 46 reads, from the monitoring video storage 61, one set of first image data, which is surrounding monitoring video data at the present time, and at least one set of second image data, which is surrounding monitoring video data at a point in time preceding the present time. The surrounding situation determination unit 46 uses an existing method for determining moving objects, such as pattern matching, to these sets of data to detect any moving object and determine the moving direction of the moving object. For example, when at least one moving object included in the first image data is larger than the corresponding moving object included in the second image data, the surrounding situation determination unit 46 determines that the moving object is approaching the door.

The predetermined distance from the doorway may change in accordance with the rate of change of a moving object, or specifically the moving speed of the moving object in the image data obtained in time series. In other words, a moving object moving faster will have a larger predetermined distance.

The destination arrival determination unit 47 determines whether the vehicle 1 has arrived at the passenger destination. The destination arrival determination unit 47 reads the destination information stored in the destination storage 63, and determines the arrival at the destination by comparing the read destination information with the current positional information indicating the current position of the vehicle 1 received from the GPS receiver 5.

The door lock controller 48 controls the door lock device 13. The door lock controller 48 causes the door lock device 13 to lock the door when the automatic driving determination unit 45 determines that the start of automatic driving or when the destination output unit 44 outputs the destination information. More specifically, the door lock controller 48 locks the door at the start of automatic driving with at least a passenger on the vehicle. The door lock controller 48 reads the surrounding situation stored in the surrounding situation storage 64 when the destination arrival determination unit 47 determines that the vehicle 1 has arrived at the passenger destination. The door lock controller 48 allows the door lock device 13 to unlock the door when the surrounding situation is safe for the passenger to exit the vehicle. In addition, the door lock controller 48 may include a seat belt locking mechanism that locks the seat belt until the fare is paid. The door lock controller 48 may control the seat belt lock in synchronization with the door lock control.

Operation

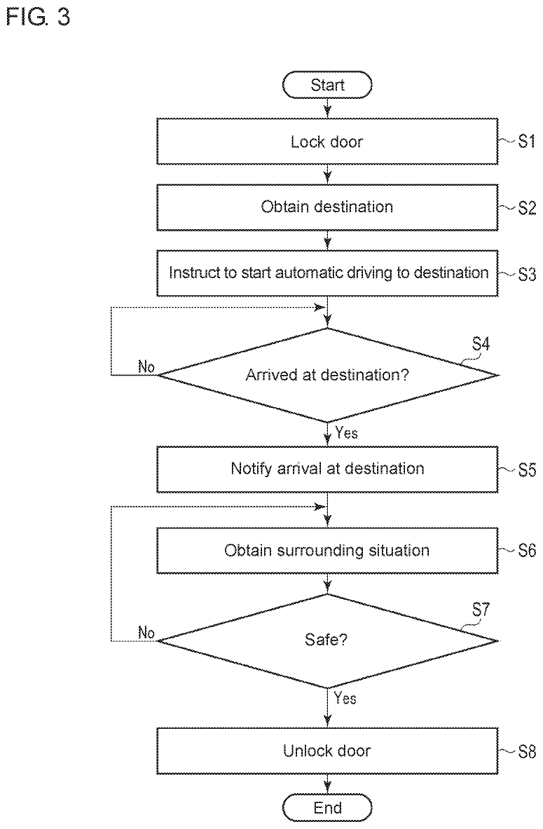

The operation of the occupant assisting apparatus 11 with the above structure will now be described. FIG. 3 is a flowchart showing the overall procedure and operation for assisting the occupant.

The procedure in the flowchart starts when an occupant enters the vehicle. The preceding procedure for finding an occupant (passenger) is provided in the taxi system using fully automated driving, and will not be described.

1. Occupant Entering the Vehicle

When an occupant enters the vehicle, the occupant assisting apparatus 11 first controls the door lock device 13 with the door lock controller 48 in the control unit 40 to lock the door in step S1.

2. Automatic Driving to Destination

In step S2, the occupant assisting apparatus 11 obtains the destination of the occupant. For example, the destination obtaining unit 43 in the control unit 40 obtains the destination information from the guidance output device 12, and stores the received information into the destination storage 63 included in the storage unit 60. In one example, the guidance output device 12 outputs guidance information asking the passenger destination, and receives an input destination through a microphone, a display, and a touch panel included in the guidance output device 12 to obtain the destination.

The door locking in step S1 may follow the processing in step S2.

Once the destination is obtained, the occupant assisting apparatus 11 instructs the automatic driving controller 4 to start automatic driving to the passenger destination in step S3. For example, the destination output unit 44 in the control unit 40 reads the destination information from the destination storage 63, and outputs the information to the automatic driving controller 4. The automatic driving controller 4 drives automatically to the destination in accordance with the output destination information.

The operation of the automatic driving controller 4 is not directly related to the present embodiment, and will not be described.

In step S4, the occupant assisting apparatus 11 waits until the vehicle 1 arrives at the destination. For example, the destination arrival determination unit 47 in the control unit 40 compares the current positional information indicating the current position of the vehicle 1 obtained by the GPS receiver 5 with the destination information stored in the destination storage 63, and determines whether these sets of information match. The processing in this step is repeated until the sets of information match.

When the vehicle 1 arrives at the destination, the occupant assisting apparatus 11 notifies the occupant of the arrival in step S5. For example, the guidance information output unit 42 in the control unit 40 outputs the guidance information indicating the arrival at the destination through the guidance output device 12.

In response to this guidance, the passenger pays the fare. This fare receiving function is provided in the taxi system using fully automated driving, and will not be described.

The operation described in all steps S2, S3, and S5 may be performed by the taxi system. In this case, the destination obtaining unit 43, the destination output unit 44, and the destination storage 63 may be eliminated from the occupant assisting apparatus 11.

To determine whether the vehicle 1 has arrived at the destination in step S4, information other than the current positional information from the GPS receiver 5 may be used as information indicating the current position of the vehicle 1. For example, the vehicle 1 may incorporate an installation positional information receiver that receives installation positional information from an installation positional information transmitter installed near a road. The installation positional information received by the installation positional information receiver may be used. The destination arrival determination unit 47 determines the arrival at the destination using the current positional information, which is a sensing result from a position detection sensor, such as the GPS receiver 5 or the installation positional information receiver.

In some embodiments, the destination arrival determination unit 47 may determine the arrival at the destination in response to a signal indicating the arrival at the destination output from the automatic driving controller 4.

3. Unlocking Door

After the passenger pays the fare, the occupant assisting apparatus 11 determines that the surrounding situation is safe for the passenger to exit the vehicle, and unlocks the door. This is performed, for example, in the manner described below.

For example, the surrounding situation determination unit 46 included in the control unit 40 reads the surrounding monitoring video data from the monitoring video storage 61 in step S6, and determines whether a moving object, such as a bicycle, is approaching the door. When the moving object is approaching the door, the surrounding situation determination unit 46 determines that the surrounding situation is unsafe for the passenger to exit the vehicle. When the moving object is moving away from the door, the surrounding situation determination unit 46 determines that the surrounding situation is safe for the passenger to exit the vehicle. The surrounding situation determination unit 46 stores the determination result into the surrounding situation storage 64.

Subsequently, for example, the door lock controller 48 in the control unit 40 reads the determination result obtained by the surrounding situation determination unit 46, which is stored in the surrounding situation storage 64 in step S7, and determines whether the surrounding situation is safe for the passenger to exit the vehicle. When the surrounding situation is unsafe for the passenger to exit the vehicle, the door remains locked.

The processing in steps S6 and S7 is repeated until the passenger exiting the vehicle is determined to be safe.

In step S7, when the determination result obtained by the surrounding situation determination unit 46, which is stored in the surrounding situation storage 64, reveals the safety for the passenger to exit the vehicle, the door lock controller 48 controls the door lock device 13 to unlock the door in step S8.

Effects

As described in detail in the above embodiment, the taxi with fully automated driving in the automatic drive mode unlocks the door after determining that the surrounding situation is safe for the passenger to exit the vehicle at the destination. Thus, the door remains locked and the occupant remains on board until an approaching moving object, such as a bicycle approaching from behind the vehicle, passes by the vehicle. This structure prevents an occupant from exiting the vehicle without noticing an approaching bicycle and colliding with the bicycle, and thus assists in ensuring the safety of the occupant.

This structure also prevents a bicycle or another moving object from colliding with a vehicle door that may be carelessly open by an occupant of the vehicle. This structure thus not only ensures the safety of the bicycle rider, but also prevents troubles between the vehicle occupant and the bicycle rider.

The structure according to the present embodiment of the present invention determines whether the surrounding situation is safe for the occupant to exit the vehicle by determining whether a moving object is approaching the corresponding door. When a moving object such as a bicycle is approaching the door, the door remains locked.

The structure according to the present embodiment of the present invention detects any moving object and determines the moving direction of the moving object using image data obtained by the surrounding camera 9 with an existing moving object detection method. This structure detects moving objects at low costs. The occupant assisting apparatus 11 uses the surrounding camera 9, which is used in the automatic driving control by the automatic driving controller 4. This structure reduces the cost associated with the occupant assisting apparatus 11.

### OTHER EMBODIMENTS

The surrounding situation determination unit 46 may detect a moving object and determine the moving direction of the moving object using a distance measurement result obtained by the radar sensor 8, in addition to or in place of the surrounding monitoring video data from the surrounding camera 9. The radar sensor 8 measures the distance between the vehicle 1 and the object around the vehicle 1. The occupant assisting apparatus 11 uses the radar sensor 8 for the automatic driving control by the automatic driving controller 4. This reduces the cost for mounting the occupant assisting apparatus 11.

Although the vehicle 1 is a taxi with fully automated driving in the above embodiment, the vehicle 1 may also be an automated private automobile.

The vehicle 1 is not limited to a vehicle with automatic driving, and may be switchable between the manual drive mode and the automatic drive mode. In this case, persons to be assisted include a driver as appropriate. Thus, the persons to be assisted include all occupants including a driver and passengers.

Further, a common vehicle without an automatic drive mode may incorporate the radar sensor 8 or the surrounding camera 9 and the occupant assisting system 10 to assist an occupant. However, when an occupant who is a driver intends to exit the vehicle, the power supply in the power unit 2 is turned off. The radar sensor 8 or the surrounding camera 9, and the occupant assisting system 10 are to be redesigned to receive operating power for a predetermined period of time after the power is off.

In some situations, an occupant does not exit the vehicle immediately after the door is unlocked. The surrounding situation determination unit 46 may monitor the surrounding situation after the door is unlocked, and may lock the door again when the surrounding situation becomes unsafe for the occupant before the occupant opens the door.

Other details including the type of vehicle, the functions of the automatic driving controller, and the procedure and the operation for assisting the occupant performed by the occupant assisting apparatus may be modified variously without departing from the spirit and scope of the present invention.

The present invention is not limited to the embodiments described above, but may be variously modified without departing from the spirit and scope of the invention. The above embodiments may be combined in any possible manner to achieve effects produced by such combinations. The above embodiments include various stages of the invention, and the components described herein may further be selected or combined to provide various aspects of the invention.

The above embodiments may be partially or entirely expressed in, but not limited to, the following forms shown in the appendixes below.

### APPENDIX 1

An occupant assistance apparatus for assisting an occupant on a vehicle, the apparatus comprising a hardware processor and a memory, the hardware processor being configured to

determine whether the vehicle has arrived at a destination of the occupant;

determine whether a surrounding situation is safe for the occupant to exit the vehicle based on a sensing result obtained from a surrounding situation detection sensor for detecting the surrounding situation of the vehicle when the vehicle is determined to have arrived at the destination, and store a result of the determination into the memory; and

unlock a door at a doorway of the vehicle when the surrounding situation is determined to be safe for the occupant to exit the vehicle based on the determination result stored in the memory.

### APPENDIX 2

An occupant assistance method implemented by an apparatus for assisting an occupant on a vehicle, the method comprising:

determining, with a hardware processor, whether the vehicle has arrived at a destination of the occupant;

determining, with the hardware processor, whether a surrounding situation is safe for the occupant to exit the vehicle based on a sensing result obtained from a surrounding situation detection sensor for detecting the surrounding situation of the vehicle when the vehicle is determined to have arrived at the destination, and storing a result of the determination into the memory; and

unlocking, with a hardware processor, a door at a doorway of the vehicle when the surrounding situation is determined to be safe for the occupant to exit the vehicle based on the determination result stored in the memory.

1. An occupant assisting apparatus for assisting an occupant of a vehicle, the apparatus comprising: a processor configured with a program to perform operations comprising:
operation as a destination arrival determination unit configured to determine whether the vehicle has arrived at a destination of the occupant;
operation as a situation determination unit configured to determine whether a surrounding situation is safe for the occupant to exit the vehicle based on a sensing result obtained from a surrounding situation detection sensor for detecting the surrounding situation of the vehicle when the destination arrival determination unit determines that the vehicle has arrived at the destination; and
operation as a door lock controller configured to lock a door at a doorway of the vehicle during travel to the destination of the occupant and to unlock a door at the doorway of the vehicle when the situation determination unit determines that the surrounding situation is safe for the occupant to exit the vehicle.

2. The occupant assisting apparatus according to claim 1, wherein the processor is configured with the program perform operations such that operation as the situation determination unit is further configured to determine whether a moving object around the doorway is approaching the door based on the sensing result obtained from the surrounding situation detection sensor, and determines whether the surrounding situation is safe for the occupant to exit the vehicle based on a result of the determination.

3. The occupant assisting apparatus according to claim 1, wherein
the processor is configured with the program perform operations further comprising operation as a destination storage configured to store the destination of the occupant, and
the processor is configured with the program perform operations such that operation as the destination arrival determination unit is further configured to determine whether the vehicle has arrived at the destination stored in the destination storage based on a sensing result obtained from a current position detection sensor for detecting a current position of the vehicle.

4. The occupant assisting apparatus according to claim 1, wherein
the vehicle comprises an automated vehicle for automatically driving to the destination of the occupant under control by an automatic driving controller included in the vehicle, and
the processor is configured with the program perform operations such that operation as the destination arrival determination unit is further configured to determine whether the vehicle has arrived at the destination of the occupant in response to a signal indicating the arrival at the destination output from the automatic driving controller.

5. An occupant assisting method implemented by an apparatus for assisting an occupant on a vehicle, the method comprising:
locking a door at a doorway of the vehicle during travel to a destination of the occupant of the vehicle;
determining whether the vehicle has arrived at a destination of the occupant;
determining whether a surrounding situation is safe for the occupant to exit the vehicle based on a sensing result obtained from a surrounding situation detection sensor for detecting the surrounding situation of the vehicle when the vehicle is determined to have arrived at the destination in the determining whether the vehicle has arrived at the destination; and
unlocking the door at the doorway of the vehicle when the surrounding situation is determined to be safe for the occupant to exit the vehicle in the determining whether the surrounding situation is safe.

6. A non-transitory computer-readable storage medium storing an occupant assisting program, which when read and executed, causes a computer to perform the operations of the occupant assisting apparatus according to claim 1.

7. The occupant assisting apparatus according to claim 2, wherein
the processor is configured with the program perform operations further comprising operation as a destination storage configured to store the destination of the occupant, and
the processor is configured with the program perform operations such that operation as the destination arrival determination unit is further configured to determine whether the vehicle has arrived at the destination stored in the destination storage based on a sensing result obtained from a current position detection sensor for detecting a current position of the vehicle.

8. The occupant assisting apparatus according to claim 2, wherein
the vehicle comprises an automated vehicle for automatically driving to the destination of the occupant under control by an automatic driving controller included in the vehicle, and
the processor is configured with the program perform operations such that operation as the destination arrival determination unit is further configured to determine whether the vehicle has arrived at the destination of the occupant in response to a signal indicating the arrival at the destination output from the automatic driving controller.

9. A non-transitory computer-readable storage medium storing an occupant assisting program, which when read and executed, causes a computer to perform the operations of the occupant assisting apparatus according to claim 2.

10. A non-transitory computer-readable storage medium storing an occupant assisting program, which when read and executed, causes a computer to perform the operations of the occupant assisting apparatus according to claim 3.

11. A non-transitory computer-readable storage medium storing an occupant assisting program, which when read and executed, causes a computer to perform the operations of the occupant assisting apparatus according to claim 4.

12. A non-transitory computer-readable storage medium storing an occupant assisting program, which when read and executed, causes a computer to perform the operations of the occupant assisting apparatus according to claim 7.

13. A non-transitory computer-readable storage medium storing an occupant assisting program, which when read and executed, causes a computer to perform the operations of the occupant assisting apparatus according to claim 8.
